(19) United States
(12) Patent Application Publication
(10) Pub. No.: US 2021/0125278 A1
(43) Pub. Date: Apr. 29, 2021

(54) SYSTEM AND METHOD FOR CALCULATING THE EXECUTABLE PRICE OF A CRYPTO-CURRENCY PRODUCT PAIR

(71) Applicant: CoinRoutes Inc., New York, NY (US)

(72) Inventors: David WEISBERGER, New York, NY (US); Ian WEISBERGER, New York, NY (US)

(21) Appl. No.: 16/963,168

(22) PCT Filed: Jan. 18, 2019
(86) PCT No.: PCT/US2019/014350

§ 371 Date: Jul. 17, 2020

Related U.S. Application Data
(60) Provisional application No. 62/618,881, filed on Jan. 18, 2018.

(51) Int. Cl. G06Q 40/04

(52) U.S. Cl. CPC G06Q 40/04; G06Q 20/065

(57) ABSTRACT

A method is disclosed. The method includes obtaining displayed price information for a product pair from a consolidated order book created from a user-selected exchange group, obtaining fee information for all exchanges in the consolidated order book for the product pair from publicly available sources of the exchanges, determining final price information for the product pair based on a comparison of discrete order sizes and the displayed price information for the product pair from the consolidated order book, and displaying, in a user interface, the final price information without displaying the individual displayed prices from the consolidated order book.

### CROSS-REFERENCE TO RELATED APPLICATIONS

This application claims the benefit of U.S. Provisional Patent Application No. 62/618,881, filed Jan. 18, 2018, the contents of which are incorporated herein by reference in their entirety for all purposes.

### FIELD OF THE DISCLOSURE

This relates to interfaces for interacting with cryptocurrencies.

### BACKGROUND OF THE DISCLOSURE

Crypto-Currency products have no definitive price for use by investors, or derivative products/markets. The CME futures product is based upon an index of arbitrarily selected exchanges using a sampling methodology over arbitrary time periods and the Cboe relies currently on one exchange's auction price at a specific time of day Media outlets and other trading systems show prices of crypto-currencies from one exchange alone, yet any individual exchange can be far above or below the prices on other exchanges. Therefore, we describe a method, implemented using software developed by CoinRoutes LLC to calculate a price, called the CoinRoutes RealPrice, based on the software's calculated price to buy and to sell a defined quantity of the crypto-currency on all markets where the local citizens can transact the product being calculated. Such prices shall be calculated periodically, so as to provide a real time view of the price of the crypto-currencies, as well as to provide a trading benchmark or a series of prices for use by derivative products.

### SUMMARY OF THE DISCLOSURE

The invention is software that utilizes CoinRoutes distributed cryptocurrency smart order router (DCCSOR) and the filter levels from the Filtered, Consolidated, Cryptocurrency Best Bid and Offer (FCCBBO), to periodically create both a bid price (RealBid), an offer price (RealOffer), and the average of both (RealPrice). The software, at each time interval, calculates the cost of buying (RealOffer) and selling (RealBid), on all eligible displayed markets for each defined filter size. Eligibility for markets is defined in each location, such as the United States, based on whether or not the market accepts deposits and withdrawals in the pricing currency and allows trading of the crypto-currency pair by residents of that locality. The defined filter sizes are maintained by the CoinRoutes system and the standard RealPrice will correspond to the third filter level in the system which, as of Jan. 13, 2018 corresponds to 5 Bitcoin, 50 Ethereum, 250 Litecoin, and 25 BitCoin Cash. The method of calculation used by the software is to create a consolidated order book from all eligible markets and determine the price to buy and sell the defined quantity for the product.

### BRIEF DESCRIPTION OF THE DRAWINGS

FIG. 1 shows the system process flow including the databases and market data components employed.

FIG. 2 shows the working user interface where the RealPrice, RealBid, and RealOffer are displayed at a point in time for BitCoin, Ethereum, LiteCoin, and BitCoin Cash in US Dollars.

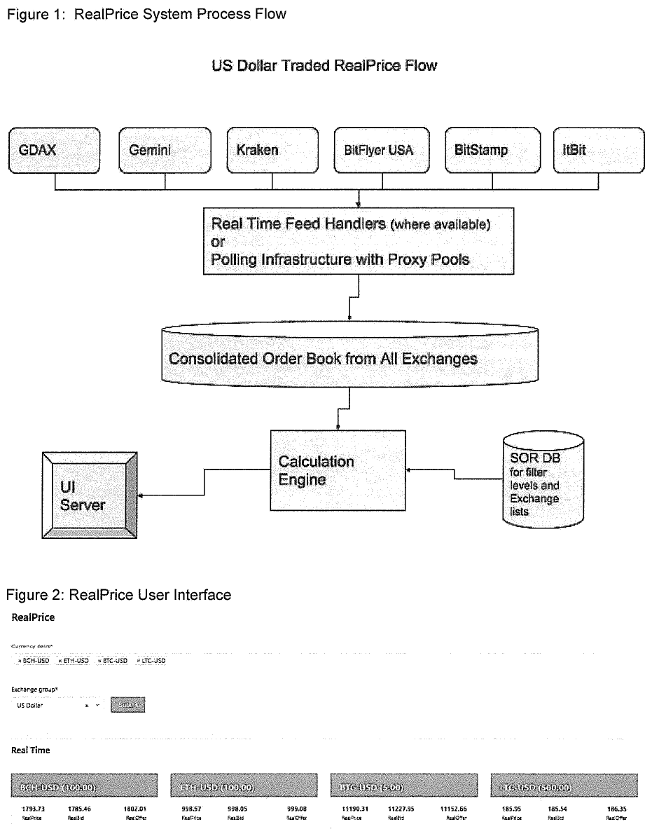

### DETAILED DESCRIPTION

The CoinRoutes RealPrice software is a system that produces a stream of prices for clients to use as a benchmark for transacting in cryptocurrencies. All cryptocurrency products are represented by a pair of currencies. In each product pair, the first is a cryptocurrency that is the primary product being traded, and the second can be either a crypto or fiat currency, which is also referred to as the pricing currency. For the sake of clarity, the first two examples of product-pairs implemented are BTC-USD and ETH-USD. In the example of BTC-USD, Bitcoin is the primary product and US Dollars is the pricing currency. In the example of ETH-USD, Ethereum is the primary product and USD is the pricing currency.

Design: The CoinRoutes RealPrice software utilizes a set of components that determine the eligible displayed markets, quantities of crypto-currency to analyze, poll or access the real time quotes from the displayed markets to create a consolidated order book, and, using that data calculates the average price that a hypothetically routed set of orders would result in. The system operates on a schedule to calculate prices at specified intervals in order to display historical movements of the price as well as to create time period averages.

Market Determination: The CoinRoutes RealPrice system has a data structure where markets (often called exchanges) are grouped by the eligibility of local residents to trade on that particular market. In the case of the RealPrice, which is designed to be denominated in currencies such as the US Dollar, for a market to be eligible, it must allow deposits and withdrawals in US dollars as well as trading in crypto-currency pairs denominated in US dollars. The CoinRoutes system has a group, called US Dollar, which as of Jan. 13, 2018 includes GDAX, Kraken, ItBit, BitStamp, Gemini, and Bitflyer USA.

Quantity Determination: The CoinRoutes system has implemented a variable called the “Size Filter” which is used for the calculation of the consolidated bid and offer throughout the system. There are five quantity amounts per crypto-asset, which for BitCoin on Jan. 13, 2018 are 0.2, 1, 5, 10, and 20 Bitcoin. The design of the CoinRoutes RealPrice is to use the third filter level for the publicly disseminated value, which for BitCoin corresponds to 5.

Consolidated Order Book Creation: The CoinRoutes RealPrice system creates a consolidated order book from all the eligible exchanges by either accessing the full order book from exchanges with accessible real time feeds or on-demand polling from exchanges without feeds. All eligible exchanges quote data is consolidated into a full order book every period, with at least the best 500 bids and offers available to the calculation module.

Price Calculation: The CoinRoutes RealPrice system calculates the RealBid and RealOffer prices by an algorithm that ranks every bid or offer in price sequence after applying the default fees maintained by the system. Once the book is sequenced, the system determines the optimal quotes to access in order to complete an order of the determined quantity. Those quotes, including the fees estimated by the system for trading against those quotes, are aggregated to calculate the RealBid and RealOffer prices. The RealPrice is the simple average of the RealBid and RealOffer.

Price Dissemination: The CoinRoutes system displays the RealPrice along with the RealBid and RealOffer for BitCoin in US dollars and other crypto-currency pairs. In addition, CoinRoutes will publish the RealPrice via an API to clients.

1. A method comprising:
obtaining price information for a cryptocurrency product pair from a consolidated order book created from a user-selected exchange group;
obtaining fee information for the exchange group in the consolidated order book for the cryptocurrency product pair;
determining final price information for the cryptocurrency product pair based on the price information for the product pair from the consolidated order book and the fee information; and
displaying, in a user interface, the final price information.

2. The method of claim 1, wherein the cryptocurrency product pair comprises a cryptocurrency and a pricing currency.

3. The method of claim 1, wherein the user-selected exchange group comprises one or more exchanges in which a user is eligible to trade.

4. The method of claim 1, wherein the consolidated order book corresponds to a first time interval, wherein the consolidated order book comprises:
a plurality of bid prices for an order size of the cryptocurrency pair in the first time interval; and
a plurality of offer prices for the order size of the cryptocurrency pair in the first time interval.

5. The method of claim 4, wherein the consolidated order book is created by accessing order books from a first exchange or by on-demand polling from a second exchange, wherein the first exchange and the second exchange are part of the user-selected exchange group.

6. The method of claim 4, wherein the fee information comprises default fees.

7. The method of claim 4, wherein determining the final price information comprises:
determining a bid price based on the plurality of bid prices and the fee information;
determining an offer price based on the plurality of offer prices and the fee information; and
determining the final price information based on the bid price and the offer price.

8. The method of claim 7, wherein determining the bid price is by ranking the plurality of bid prices after applying the fee information, and wherein determining the offer price is by ranking the plurality of offer prices after applying the fee information.

9. The method of claim 7, wherein the final price is an average of the bid price and the offer price.

10. The method of claim 4, wherein the order size is a first order size and the final price information is a first final price information, the method further comprising determining a second final price information corresponding to a second order size for the first time interval.

11. The method of claim 10, wherein the user interface comprises a filter for selecting the first order size and the second order size.

12. The method of claim 1, wherein the cryptocurrency is bitcoin.

13. The method of claim 4, further comprising creating a second consolidated order book corresponding to a second time interval.

14. An electronic device, comprising:
a display;
one or more processors;
a memory; and
one or more programs, wherein the one or more programs are stored in the memory and configured to be executed by the one or more processors, the one or more programs including instructions for:
obtaining price information for a cryptocurrency product pair from a consolidated order book created from a user-selected exchange group;
obtaining fee information for the exchange group in the consolidated order book for the cryptocurrency product pair;
determining final price information for the cryptocurrency product pair based on price information for the product pair from the consolidated order book and the fee information; and
displaying, in a user interface, the final price information.

15. A non-transitory computer-readable storage medium storing one or more programs, the one or more programs comprising instructions, which when executed by one or more processors of an electronic device having a display, cause the electronic device to:
obtaining price information for a cryptocurrency product pair from a consolidated order book created from a user-selected exchange group;
obtaining fee information for the exchange group in the consolidated order book for the cryptocurrency product pair;
determining final price information for the cryptocurrency product pair based on price information for the product pair from the consolidated order book and the fee information; and
displaying, in a user interface, the final price information.
